(19) United States
(12) Patent Application Publication
(10) Pub. No.: US 2009/0246742 A1
(43) Pub. Date: Oct. 1, 2009

(54) Interactive Storytelling Kit & Method

(75) Inventors: Amos NADAN, Jerusalem (IL); Noga LEVZION-NADAN, Jerusalem (IL)

Correspondence Address: HOUSTON ELISEEVA, 4 MILITIA DRIVE, SUITE 4, LEXINGTON, MA, 02421, US

(73) Assignee: Yaroma Ltd., Jerusalem (IL)

(21) Appl. No.: 12/433,139

(22) Filed: Apr. 30, 2009

Related U.S. Application Data
(63) Continuation of application No. PCT/IL2007/001319, filed on Oct. 30, 2007.
(60) Provisional application No. 60/855,125, filed on Oct. 30, 2006.

(51) Int. Cl. G09B 19/00; A63H 33/00

(52) U.S. Cl. 434/128; 446/75

(57) ABSTRACT

An interactive play kit comprising at least one changeable setting, at least one representative object, a primary cue-card containing a fixed outline of a story adapted for development of a primary story, and at least one secondary cue-card containing guidelines adapted for development of a secondary story being a variation of the primary story. The aforementioned at least one representative object is adapted to be movably placed and displaced within the at least one changeable setting so as to convey either the primary story or the secondary story.

### RELATED APPLICATIONS

This application is a Continuation of International Application No. PCT/IL2007/001319, filed on Oct. 30, 2007, which in turn claims the benefit under 35 USC 119(e) of U.S. Provisional Application No. 60/855,125, filed on Oct. 30, 2006, both of which are incorporated herein by reference in their entirety.

### FIELD OF THE INVENTION

This invention relates to storytelling kits, more particularly to kits adapted to develop one's cognitive skills.

### BACKGROUND OF THE INVENTION

It is well appreciated that creativity and imagination are important in stages of a child's development. The imaginative experience gives the opportunity to develop a full range of human potentials, among them the improvement of capacities for thought, communication, nurture feeling, sensibility, physical and perceptual skills, and explores values. Further, healthy creativity and imagination provide skills to deal with the unexpected, extend current knowledge to new situations, bring together previously unconnected information, use information in a new innovative way, experiment with novel concepts, deal with incessant changes, be able to reappraise values and ways of working, modify and monitor an individual's world, think flexibly, play with ideas and materials, work with people from a diversity of cultures, language and religions, empathize with others, collaborate in various ways with different people, take rational risks, be innovative, respond imaginatively to challenges, etc. [see in this connection Bernadette Duffy, Supporting Creativity and Imagination in the Early Years (Buckingham: Open University Press, 2nd edition, 2006).].

### SUMMARY OF THE INVENTION

According to a first aspect of the present invention there is provided an interactive play kit comprising at least one changeable setting, at least one representative object, a primary cue-card containing a fixed outline of a story adapted for development of a primary story, and at least one secondary cue-card containing guidelines adapted for development of a secondary story being a variation of said primary story, wherein said at least one representative object is adapted to be movably placed and displaced within said at least one changeable setting so as to convey either said primary story or said secondary story.

Said kit may be used to develop one or more cognitive skills of an individual. A cognitive skill refers to any mental process, including, without being limited thereto, emotional intelligence, awareness with perception, reasoning and judgment, intuition, memory, thinking, imagining, social skills, and learning words. In the context of the present invention, the term cognitive skill may also encompass motor skills.

According to one embodiment, the kit may be used to develop one or more cognitive skills of infants or young children.

According to yet another embodiment, the kit may be used to develop one or more cognitive skills of a variety of individuals such as young children, having special needs and/or disabilities. For example, in the case of Autistic Spectrum Disorders (ASD)/Pervasive Developmental Disorders (PDD)—broadly defined, the invention can be use to assist in developing in challenging areas such as where difficulty may exist in non-verbal and verbal communication skills, social skills, the expression of feelings—such as empathy, representational play and eye-hand linkage.

The kit is especially useful for developing creativity and imagination of children.

The kit preferably further comprises at least one Storage space for storing said changeable setting, said at least one representative object, said primary cue-card and at least one secondary cue-card. Said at least one Storage space may contain partitions adapted to form storage compartments within said storage space for better organizing one of said changeable setting, at least one representative object, primary cue-card and at least one secondary cue-card. Said partitions may be modular, i.e. be displaced within said compartment to form different size compartments for storage of one of the above.

It would also be acknowledged that both primary and secondary cue cards may be separate from the storage space, changeable setting and representative objects, whereby they may be used for a plurality of kits, each kit having a different changeable setting, thereby further increasing the range of stories, imagination and experience of the user.

The changeable setting may correspond to said fixed outline of the story as detailed in the primary cue-card and may form a display space similar to a stage with decorations, wherein said individuals may apply elements to said stage and decorations in such a way that stimulates the sense of touch and also facilitates better understanding and relating to the story. For example, the changeable setting may be formed of plasticine, different fabrics or the like to obtain a touchable texture. The changeable setting may also allow a user to physically change the setting itself, for example, playing with the plasticine to change the form thereof, differently layering of the fabric etc. The changeable setting may be connected to the Storage space and even form a cover, or any other part thereof. Further, the changeable setting may be formed from one or more interconnected panels. In addition, the kit may comprise several changeable settings relating to the story, allowing replacing of the setting according to the cue-cards to facilitate a richer and more imaginative story environment.

According to a specific embodiment, said changeable setting may constitute said storage space, for example, the interconnected panels may assume the shape of a 3D box when used as a storage space and be unfolded when used as a changeable setting. It would also be appreciated that the changeable setting may be used even in when being used as a storage space.

The changeable setting and said at least one representative object may allow representation of said primary or said secondary story. It is well appreciated that children need to represent their experiences, their feelings and ideas. They use their representations to explore, to solve problems, to think about and create new meanings. The children make use of the variety of sources, such as the changeable setting and associated representative objects, which are fused together to produce an integrated new and creative whole.

The kit itself may be transposed between an open position in which said panels of the changeable setting are deployed and a closed position, in which said changeable setting is folded to obtain a shape similar to that of a book, whereby it may be placed on a book shelf next to real books, thereby functioning, for any practical purpose, as a regular storytelling book.

According to one embodiment, said kit may be constituted by a plurality of elongated chambers having a matching geometry, each chamber having a top and a bottom surface of a specific geometric shape, e.g. triangle, rectangle, star etc. and side walls extending between said top and said bottom surface. One of said top and bottom surfaces may constitute a flap or a cover allowing access to the inner space of the chamber. The side walls may be formed with openings which may be used as part of the changeable setting, for example, a window, a door etc.

The chambers may be pivotally interconnected, for example, via the edges between two side surfaces, to form a chamber chain. Thus, the chamber chain may assume various shapes, and the chambers may be organized side by side such that the side surface of one chamber is mated against the side surface of an adjacent chamber, whereby the top and bottom surfaces may form a tessellated top and bottom surfaces respectively. Thus, the chamber chain may constitute both storage space and changeable setting.

According to a specific design, the kit may be formed with five prism-like chambers, For example of triangular shape, each chamber having a top and bottom surfaces, whereby organizing the chambers as previously mentioned provides for a box having a top and bottom surfaces with a pentagonal geometry.

The kit as described above may also comprise a securing arrangement adapted for maintaining the chambers in the pentagonal configuration. The securing mechanism may be a strap wrapped around the side surfaces of the chambers, a clip mechanism or the like.

In addition, the changeable setting may be formed with anchor points corresponding to certain episodes and/or stages of said story and/or story variations to which said at least one representative object may be attached in a removable manner. Such anchor points may be constituted by a sticky surface, Velcro®, magnet or the like. Additional anchor points may be added to the changeable setting, for example, plasticine or clay stripes to which representative and other objects may be attached.

The kit may comprise a plurality of representative objects. The objects may be two or three dimensional and much like the changeable setting may have a touchable texture, allowing the individual to stimulate the sense of touch. The representative objects may constitute characters, objects or ideas from the story laid down in the primary cue card, e.g. a girl with a red hood in the case of “little red riding hood” or a glass slipper in the case of “Cinderella”. However, the representative objects may constitute variations of objects or ideas from the story, e.g. a little boy with a red bag in the case of little red riding hood.

Furthermore, the representative objects may be modular, for example, objects representing characters may have replaceable head/limbs/torso to allow a user to construct new and even fictional characters to fit the variations of the primary story or even a completely different story. The representative objects may even be made without specific human/animal characteristics, and may be made of simple geometric 3D units. For example, little red riding hood may be represented by a cube and a red pyramid positioned thereon.

The primary cue-card may contain one or more sheets. The fixed outline in the primary cue-card may be in a variety of forms spanning from the original full text of the story (a higher level of understanding) to a shortened pointer version summarizing only the actions and positions of the heroes (lower level of understanding), e.g. red riding hood in the forest→wolf meets red riding hood etc., and even in the form of visual images.

The kit may contain a plurality of secondary cue-cards, wherein each cue-card may contain a number of sheets. The guidelines of the secondary cue-cards may, according to a specific embodiment, contain a built-in variation of the fixed outline story, and according to another specific embodiment, contain blank spaces for a user or an individual to fill in said blank spaces according to his/her imagination and creativity, thereby changing the plot of the story or producing an integrated new and creative story, making use of the secondary cue-card, the changeable setting and the representative objects as the source for the new creation. For example, a variation on the story of “little red riding hood” may be developed where the wolf does not eat the grandmother.

The secondary cue-cards may also be adapted for personalization of the story, for example, a father may have his own secondary cue-card, “Dad's story”, containing his variation on the story of the primary cue-card and a mother may have her own card. This allows individuals, and especially children to better connect to the story and sympathize with it.

The secondary cue-cards may also be designed to be divided into levels in order to allow an individual to gradually develop and stretch the boundaries of the story and his/her cognitive skills. For example, a level 1 cue-card may contain guidelines allowing only slight variations from the fixed outline whereas level 5 may allow an almost individual story constructed by the user, which is loosely based on said fixed outline.

Both primary cue-card and said at least one secondary cue-card may contain, in addition to said fixed outline and said guidelines, a set of instructions implanted in the text, adapted to aid the individual in playing out the story, e.g. telling him where/how/when to place said at least one representative object etc. For example, it may be stated in the cue-card: “Little red riding hood” [take out the little red riding hood doll out of the Storage space and present it] went into the forest [place the doll in the forest of the changeable setting] and so on and so forth.

The aforementioned levels and instructions are also adapted to allow a child or an individual with special needs as previously mentioned to operate the kit.

According to a specific embodiment, the primary cue-card and the secondary cue-card may constitute part of a leaflet/booklet comprising one or more pages, whereby turning the pages of the leaflet provides variations for creating the story. For example, the leaflet may have several sections, and may have a front side containing guide-lines for the primary story and constituting the primary cue-card, and a rear side containing guide-lines for the secondary story and constituting the secondary cue-card. Thus, by flipping over one of the sections, the guidelines on the rear side of the leaflet may be combined with the guidelines on the front side of the leaflet to produce guidelines for a new story.

It should be appreciated here that the changeable setting and said representative objects may fully serve various sets of primary and secondary cue-cards relating to different stories, allowing the kit to become versatile and not confined to one specific story outline. For example, a changeable setting showing a forest (as in the case of “Little red riding hood”) may also be used as a forest setting for “Snow white” and a representative object like a hunter may become the prince in “Cinderella”. This allows for a great diversity for the user while also allowing the kit to be used for several stories.

The kit may further comprise at least one data storage and/or display apparatus, e.g. audio/vide tape, CD etc. adapted to provide audio-visual input/output corresponding to said story or story variations, thereby stimulating the senses of sight and hearing of an individual. Said at least one apparatus may also be adapted to display instructions for the individual playing out the story or story variations, e.g. in the form of a user manual.

Furthermore, said apparatus may be used to record the playing out of the story, visually and/or aurally, e.g. video/audio recorder, so it may be replayed by the individual, thus personalizing the Interactive Play Kit (hereafter IPK). The apparatus may also be adapted for music to be imported thereto, for example MP3, in order to provide background music accompanying the story according to the individual's choice.

According to one embodiment, the above mentioned apparatus may also be used to record the voice of the individual playing out the story, allowing a child, for example, to have a recording of his version of the story, for example, his father's version of the story and so on. The apparatus may also be designed to provide a soundtrack or background music for the story, and according to a specific embodiment, the user may either choose one musical theme from a specific list or provide his/her music by importing it into the kit.

According to a second aspect of the present invention there is provided a method for development of imagination, said method including:
a. Providing an interactive play kit comprising at least one changeable setting, at least one representative object, a primary cue-card containing a fixed outline of a story adapted for development of a primary story, and at least one secondary cue-card containing guidelines adapted for development of a secondary story being a variation of said primary story, wherein said at least one representative object is adapted to be movably placed and displaced within said at least one changeable setting so as to convey either said primary story or said secondary story.
b. Playing out said primary story according to the fixed outline of said primary cue-card by placing the appropriate representative objects within said at least one changeable setting as said story progresses.
c. Playing out said secondary story, differing from said primary story, according to the guidelines of one of said at least one secondary cue-card by gradually placing the appropriate representative objects within said at least one changeable setting as said story variation progresses.
d. In accordance with an alternative embodiment of the IPK according to the present invention, at least part of said secondary cue-cards are in the form of playing cards containing either verbal or visual information which assists in the development of a secondary story. Further, as an alternative to the above, the story may be played out by withdrawing playing cards from a pile of such cards.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic isometric view of an interactive play kit in a closed position according to one embodiment of the present invention;

FIG. 2 is a schematic isometric view of the interactive play kit of FIG. 1 in an open position;

FIG. 3 is an enlargement of detail A of FIG. 2;

FIG. 4 is a schematic view of a number of modular representative objects which may be used in the interactive play kit of FIG. 1;

FIGS. 5A and 5B are schematic views of a primary cue-card and a respective secondary cue-card, according to one embodiment of the present invention;

FIGS. 5C and 5D are schematic views of a leaflet constituting the primary cue-card and secondary cue-card according to another embodiment of the present invention;

FIGS. 6A and 6B are schematic block diagrams showing the variations of the story of the IPK according to the primary cue-card and a secondary cue-card thereof, respectively;

FIGS. 7A and 7B are an illustration of an embodiment of the changeable setting of the IPK of FIG. 1 in closed and open positions respectively;

FIG. 10 is an isometric view of a storage space according to one embodiment of the present invention;

FIG. 11A is an isometric view of the storage space shown in FIG. 10 in a semi-deployed position;

FIG. 11B is an isometric view of the storage space shown in FIG. 10 in a fully deployed position; and

FIG. 12 is an isometric view of a storage chamber, constituting part of a storage space shown in FIG. 10.

### DETAILED DESCRIPTION OF THE PREFERRED EMBODIMENTS

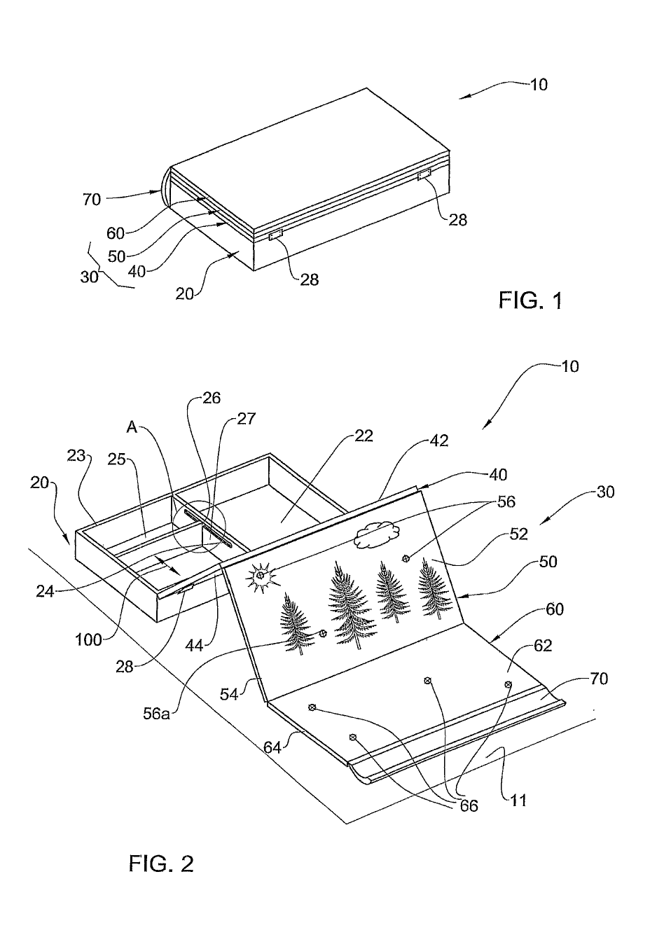

FIG. 1 shows an Interactive Play Kit (hereinafter ‘IPK’) generally designated 10, comprising a Storage space 20, and a changeable setting 30. The setting 30 comprises a cover panel 40, a decoration panel 50 and a stage panel 60, folded together, one on top of the other to cover the Storage space 20. The changeable setting 30 is attached to the storage space 20 by two hinges 28. A flap 70 is attached to the stage panel 60 in order to provide the IPK 10 with a book-like appearance.

FIG. 2 shows the IPK 10 in an open position. In this position, the cover panel 40 hinged to the storage space 20 at 28 is raised, exposing the storage space 20. The cover panel 40 forms a triangle shape with the decoration panel 50, and the stage panel 60 lies horizontal on a surface 11. In this position it is possible to place objects on the stage panel 60, whereby the decoration panel 50 serves as a background decoration. The flap 70 also lies horizontally and forms a continuation of the stage panel 60. The decoration panel 50 and the stage panel 60 both contain a number of anchor points 56 and 66 respectively. The anchor points are adapted for attachment of representative objects for presentation of the story and/or other objects serving as a base for the representative objects, e.g. a stand to which characters may be secured or positioned on.

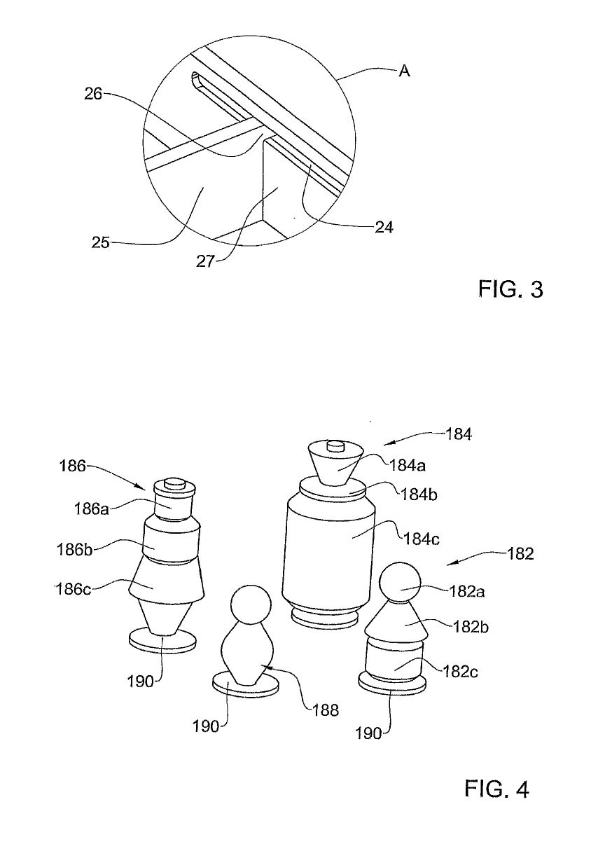

The storage space 20 is divided into compartments 22 by means of several barriers—in this particular example, a primary barrier 27 and a secondary barrier 25. The barrier has a prolonged incision 24 which is adapted to allow the secondary barrier 25 to slide back and forth in direction of arrow 100, allowing modular formation of the compartments 22 of the storage space 20. The secondary barrier has a bulging protrusion 26 which is adapted to slide within the incision 24 as can be seen from the enlargement in FIG. 3.

The storage device 20 may alternatively or in addition be of a dimension to carry real size costumes, so as to allow users, e.g. a child to actually perform one or more characters of the story.

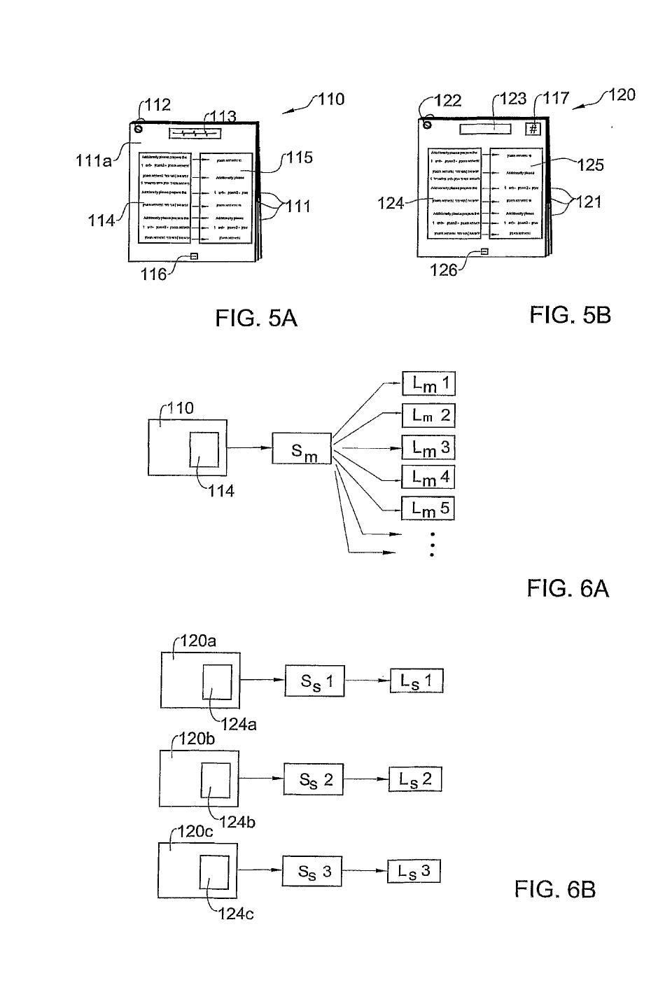

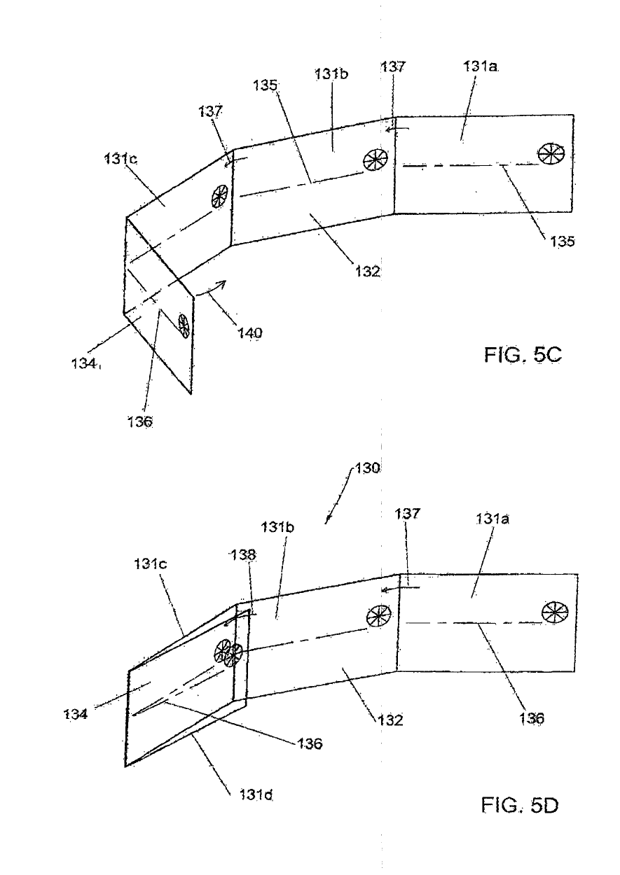

According to the present embodiment, the IPK 10 revolves around the “Little red riding hood” story theme, wherein the changeable setting 30, representative objects (e.g. as shown FIG. 4), primary cue-card and secondary cue-cards (e.g. as shown FIGS. 5A and 5B) are all designed and adapted to comply with the theme of the story as will be explained in detail later.

FIG. 2 shows that the panels 40, 50, 60 are designed with various decorative objects 58 such as a sun, sky, clouds, the texture of which may be felt by a child, made of a variety of materials including, without being limited thereto, cloth, plastic, a plasticine, or plasticine like material in various colors depicting a forest environment, suiting the forest in the Little red riding hood story.

The panels 40, 50, 60 may, at times, be covered with playable decorative objects 58, such as plasticine. Thus, the child may also, to a certain extent, change the setting 30 by re-forming the plasticine. For example, he/she may make the sun smaller and change the formation of plasticine made clouds.

The anchor points 56, 66 are positioned on the panels 40, 50, 60 according to the story, for example, an anchor point 56a is located on the decoration panel 50 in the area depicting a forest, to allow placement of the hunter (shown FIG. 4) from the “Little red riding hood” story therein as will be explained later. The anchor points 56, 66 may be displaced along the panels either being in the form of a thumb-tack, or having a sticky surface or simply embedded in the plasticine. This allows positioning of anchor points in certain parts of the changeable setting 30 in order to fit different variations of the story as will be explained in detail later. It may also fit for other stories.

The panels 40, 50, 60 are so designed that whereas the front side surfaces 42, 52 and 62 of the decoration panel 50 and stage panel 60 respectively are adapted to comply with the primary (fixed) story as well as with variations thereof, the rear surfaces 44, 54 and 64 are adapted to comply with other variations of the primary story or even with a different story. This way, the changeable setting 30 may be flipped over, turning the rear surfaces 44, 54 and 64 into front surfaces depicting a different story. With respect to the latter option, the front surfaces 52, 62 may be designed in the theme of “Little red riding hood” and the rear surfaces 54, 64 in the theme of “The sleeping beauty”. [See above]

The collection 80 of representative objects 81-89 may include a doll 81, a picnic basket 82, a mother doll 83, a hunter doll 84, a rifle 85, a grandmother doll 86, a big bad wolf doll 87 two houses 88 and trees 89, etc. Additional objects which may be included in the kit and are regarded as auxiliary objects 90 comprise, for example, a playable (e.g. plasticine) strip 92 which may be secured to anchor points 66 of the stage panel 60. The strip is adapted for the representative objects 80 to be embedded therein in order to stand securely on the stage panel 60.

FIG. 4 illustrates various representative characters 180, for example a woman 182, a queen 184, a man 186 and a little boy 188. Each representative character 180 is comprised of several segments, for example, the woman 182 has a head segment 182a, a chest segment 182b, and skirt segment 182c in order to make it completely modular. The segments are each threaded on a stand comprising a base 190 and a pole (not shown). The segments may be switched in order or from one stand to another, thus allowing the creation of an array of characters, for example a queen's head segment 184a, a woman's skirt segment 182c and a man's chest segment 186b. The modularity of the figures allows the user to develop his/her imagination and corresponds to the general spirit of the invention that everything may be changed by the user.

Turning now to FIG. 5A where a primary cue-card 110 is shown. In this particular embodiment, the primary cue card is made up of a number of laminated sheets 111 connected together using a ring 112. The sheets 111 are numbered 116 and contain a title area 113, a fixed outline area 114 and an instructions area 115.

FIG. 5B shows a secondary cue-card 120, which, in accordance with this non-limiting embodiment is also made up of a number of laminated sheets 121 connected together using a ring 122. The sheets 121 are numbered 126 and contain a blank title area 123, a guideline area 124 and an instructions area 125. The blank title area 123 allows personalization of the secondary cue-card 120, e.g. a father may write “Father's story” in the blank title area 123. In addition, the sheets 121 contain a level indicator 117. The levels will be explained in detail later.

In operation, there are various stages of playing out the primary story according to the primary cue-card 110 from start to finish. In the present embodiment, an adult, e.g. father, mother etc. plays out the story for a child, according the fixed outline 114 and instructions 115 of the primary cue-card 110.

During the aforementioned stages, the text of the story dictated by the fixed outline 114 is read from the primary cue-card 110 and, according to instructions 115 therein, the representative objects 80 are taken out of the storage space 22 and placed and/or displaces within the changeable setting 30.

Turning now to FIGS. 5C and 5D, another configuration of primary cue-cards 110 and secondary cue-cards 120 is shown in the form of a leaflet 130. The leaflet 130 has several pages 131a, 131b etc., and a front side 132 and a rear side 134.

The front side 132 of the pages 131 contains guide-lines 135 for the primary story which constitute the guidelines 136 of the primary cue-card 110, and the rear side of the pages 131 contains guide-lines for the secondary story which constitute the guidelines of the secondary cue-card 120.

In operation, when the story is developed along the guidelines 135 of the primary cue-card, the story is played out in the order of the arrows 137. However, once a page is flipped, for example page 131d, in the direction of arrow 140, the new story which may be developed follows first the guidelines 135 of the primary cue-card 110 on the front side 132 of the leaflet 130, and then continue in the direction of arrow 138 to the guidelines 136 of the secondary cue-card 120 on the rear side 134 of the leaflet 130. This allows alternating the story with the same beginning. It would also be appreciated that the leaflet 130 may comprise a varying number of pages 131, and the number of pages 131 flipped may vary, i.e. two pages 131c, 131d flipped together etc. It would also be appreciated that a variety of options for story development.

In order to use the IPK 10, the cover panel 40 is first opened and the changeable setting 30 is unfolded, in order for to provide an environment and atmosphere for the story using the stage panel 60 and decoration panel 50. One or more representative objects 80 may be then connected to the anchor points 56, 66 of the changeable setting 30 to serve as a base for other auxiliary objects 90 that are used when playing out the story, e.g. a stand to which characters may be secured in the form of the plasticine strip 92.

Referring to FIGS. 6A and 6B, in operation, the process of using an IPK such as that described with respect to aforementioned figures may include an almost endless number of levels ‘L’, but they may essentially be divided into two types of levels:
a. Primary cue-card levels ‘Lₘ’—In these levels, the primary story ‘Sₘ’ is developed according to the fixed outline 114 of the primary cue-card 110, the levels ‘Lₘ’ being dependent mostly on ways of playing out essentially the same primary story ‘Sₘ’, as seen in FIG. 8A.
b. Secondary cue-card levels ‘Lₛ’—In these levels, the primary story is modified, each time according to the guidelines 124a, 124b etc. of a different secondary cue-card 120a, 120b etc. allowing modification not only of the “playing out” but actually creating different secondary stories ‘Sₛ’. The levels ‘Lₛ’ may gradually progress from a story with only slight variations from the original fixed outline 114 to a completely different story which is only loosely based upon the fixed outline 114, as seen in FIG. 8B.

According to one embodiment, the operation of the IPK 10 involves first playing out the primary story according to the fixed outline 114 of the primary cue-card 110 in order to get the child familiar with the characters, scenery, story etc. and then progressing on to making modifications either according to primary cue-card levels or secondary cue-card levels. The primary story in the fixed outline of the primary cue card may be played at different levels (as identified by the level indicator), a low level providing general identification of the characters and basic scenarios within the primary story, to a high level where the entire primary story is stringently played.

The following is a partial description of a played out story of “little red riding hood” according to a fixed outline 114 of a primary cue-card 110. The quoted text refers to the fixed-outline 114 of the primary cue-card 110, which should be read out loud to the child. The italic text refers to the instructions of the primary cue-card, for the adult playing out the story:
“Once upon a time there was a forest” (Take out some trees and place them on the stage panel and decoration panel and introduce them as ‘the forest’); it should be noted that these instructions may also appear by way of illustrations instead of the alongside script.
In the forest stood a lovely little house” (Take out one of the houses, introduce it to the child and let him place it on the plasticine strip. Alternatively, you may place it yourself).
“And in the lovely little house lived little red riding hood (Take out the little red riding hood doll and place it on the plasticine strip next to the house) and her mother” (Take out the mother doll 83 and place it on the plasticine strip next to little red riding hood).
“One day the mother gave little red riding hood a picnic basket.” (Take out the picnic basket, present it to the child and put it in little red riding hood's hand).

This process continues by the same method until the story is played out to the end. During the playing out of the primary story, the characters may be displaced within the changeable setting 30, e.g. little red riding hood 81 may be moved through the forest 89 into grandmother's house 88.

Once the primary story has been played out through, the representative objects 80 are collected back to the storage space 20, allowing the playing out of a new story, either according to the fixed outline 114 of the primary cue-card 110 again or according to guidelines 124 of the of the secondary cue-cards 120.

The development of the primary cue-card levels is fairly simple and will not be discussed here in detail. It essentially includes the above steps with instructions allowing the child more freedom only in deciding the physical playing out of the game. This is all done without sidetracking from the fixed outline 114 of the primary cue-card 110.

An example of a number of primary cue-card levels is as follows:
i. The adult reads the text based on the fixed outline 114, takes out the representative objects 80 from the storage space 20, presents them and the child is the one to place them in the changeable setting 30.
ii. The adult is in charge of reading the text based on the fixed outline 114, and the child is the one responsible for taking out the appropriate representative objects 80 and placing them within the changeable setting 30.
iii. The child reads the text based on the fixed outline 114 and essentially operates the IPK 10 on his own.

It should be noted here that an almost infinite number of levels and variations on playing out the fixed outline 114 of the primary cue-card 120 is available and is not confined to the three above mentioned levels.

This process allows the child to better connect visually and emotionally to the story and the characters and stimulates the development of imagination as well as pattern recognition. The play options (reading the text, placing the characters etc.), gradually revealed to the child, make him feel he is broadening his perspective and consequently his imagination. Furthermore, the freedom the child has in “calling the shots” helps stimulate self confidence and lets a child feel in control of things.

The following is a partial description of a played out secondary story of “little red riding hood” according to guidelines 124 of a secondary cue-card 120. The quoted text refers to the guidelines 124 of the secondary cue-card 120, which should be read out loud to the child. The italic text refers to the instructions 125 (Shown FIG. 5B) of the secondary cue-card 120, for the adult playing out the secondary story:

“Once upon a time there was a forest” (Take out some trees and place them on the stage panel and decoration panel and introduce it as ‘the forest’)
In the forest stood a lovely little house” (Take out one of the houses, introduce it to the child and let him place it on the plasticine strip. Alternatively, you may place it yourself).
“And in the lovely little house lived ______ (Let the child fill out the blank, then take out the appropriate doll and place it on the plasticine strip next to the house) and her ______” (Let the child fill in the blank, then take out the appropriate doll and place it on the plasticine strip next to the previous character).
“One day the ______ (Fill in the blanks according to the previous step) gave ______ (Fill in the blanks according to the previous step) a ______” (Let the child decide on the object, then take out the appropriate object, present it to the child and put it in the appropriate character's hand).

In this way, the child may construct a secondary story, for example, telling about little red riding hood who lived in a house in the forest with her wolf and they both went to the hunter to ask him to stop hunting wolves.

This process continues by the same method until the secondary story is played out to the end. Once the process is done, the secondary story may be played out from the beginning according to guidelines 124 of a different secondary cue-card 120.

It should be noted here that secondary cue-cards 120 may be personalized. For example, after playing out a secondary story according to a certain secondary cue-card 120, the adult may sign his name in the title area 123 (FIG. 5B) e.g. “Father's version”, so that when a child asks to hear the secondary story he and his father constructed, the secondary cue-card 120 may be used again. In this essence, the personalized secondary cue-card 120 becomes similar to a primary cue-card 110 telling a version of the story.

In addition to the effects mentioned before with regards to the primary cue-card 110, this process allows the child to develop the story and characters himself, and requires the child to constantly use his imagination to accomplish this development. Nevertheless, the child does not feel pressured to complete a task and may gradually develop the story at his own pace.

According to another embodiment, the secondary cue-cards of the IPK 10 are in the form of a set of regular sized playing cards that may be used for the development of an almost ever-changing story with many creative and imaginary variations. One example for the use of playing cards may be that the primary story of little red riding hood is being told up to the point where the wolf meets little red riding hood for the first time. Then the child has to withdraw one playing card. He withdraws a card that resembles a peaceful situation and may say for example: “the wolf is a nice guy; he shows the girl the way to her grandmother's house,” then the child walks the two characters to the house. Then, another child may pick up another playing card and withdraw a card that resembles anger, saying, for example: “the grandmother is very angry, she tells the girl not to go with strangers.” etc.

According to another embodiment, the IPK 10 further comprises a data storage and display apparatus 140 in the form of an audio cassette, CD, DVD or the like, allowing the adult and child to record their story or version of the story during its play out. In this way, a child may operate the IPK 10 on his own, still being able to listen to familiar stories and voices as if the adult is playing with him. This also facilitates the development of imagination since the child needs to imagine the actual person represented by the voice coming from the apparatus 140.

According to this embodiment, the apparatus 140 also has a display screen 142, allowing the electronic display of primary cue-card 110, secondary cue-cards 120 and even a tutorial 150 for individuals taking their first steps with the IPK 10. Furthermore, the apparatus 140 allows the user to import music so that the IPK 10 provides background music for the story according to the user's choice. According to a specific embodiment, the apparatus 140 is adapted to be connected to a computer 144, allowing the user to download new cue-cards 110, 120, new stories etc.

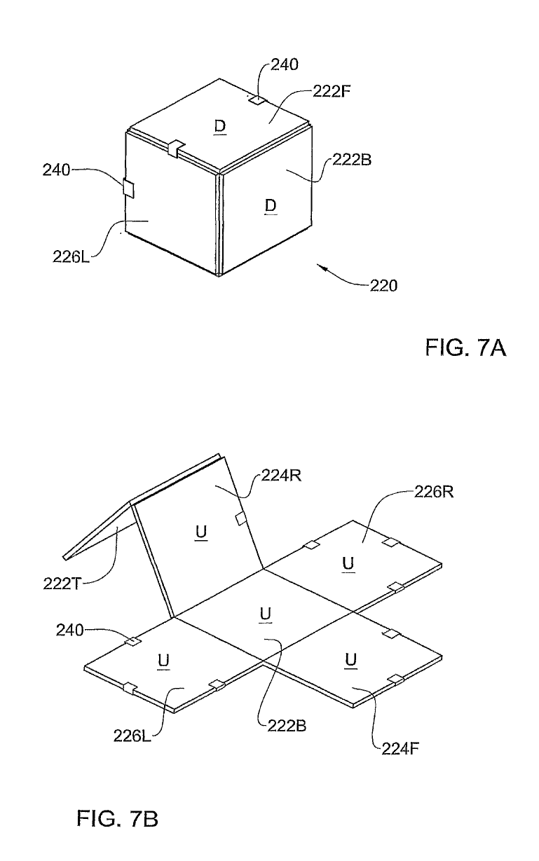

According to another embodiment of the IPK 10 presented in FIGS. 7A and 7B, there is provided a storage space 220 comprising a base and top walls designated 222B and 222T respectively, front and rear side walls designated 224F and 224R respectively, and left and right side walls designated 226L and 226R respectively. Each of the walls having an up side and a down side designated ‘U’ and ‘D’, which will be discussed later in detail.

Each wall has at least one Velcro® strip in order to connect to other walls, allowing the storage space 220 to assume a closed position (FIG. 7A), forming a cube in which representative objects 80, cue-cards 110 and 120 of the IPK 10 may be stored, as well as other objects. In this position, the down sides ‘D’ are directed outwards.

When assuming an open position (FIG. 7B), the walls are opened so that the down sides ‘D’ of the front, left, right and base 224F, 226L, 226R and 222B respectively create a platform, constituted by the up sides ‘U’. The up side ‘U’ of the rear wall 224R is positioned angled to the base wall 222B so as to create a background for the platform.

It should be noted here that the walls may be connected to each other by various means, Velcro® fastener being only one of them.

Although not illustrated, it should be understood that the walls are adapted to accept various background attached thereto in order to create a more suitable environment for using the IPK 10. Alternatively, the walls may be pre-painted or pre-fabricated in order to have a specific background matching a certain story.

It should be appreciated that the setting assemblies may comprise a greater number of pieces for providing a more diverse range of setting possibilities.

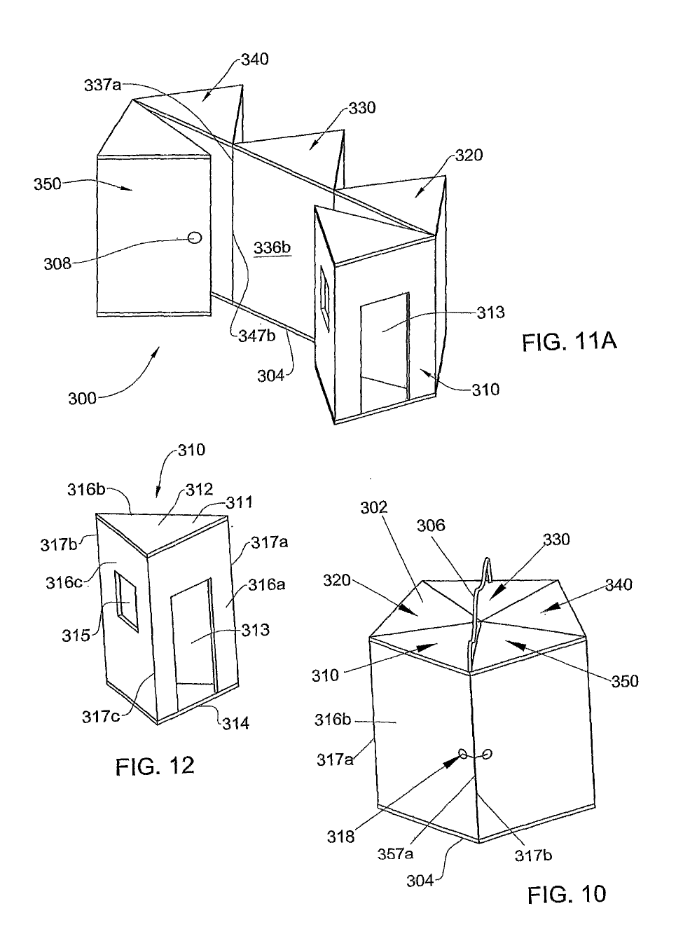

Turning now to FIGS. 10 to 12, yet a further embodiment of the storage space of the IPK is shown, generally designated 300. The storage space 300 has a top and bottom surfaces 302, 304 respectively of an essentially pentagonal shape. The storage space 300 is formed of five hollow storage chambers 310-350 which are pivotally interconnected, and in the present figure the storage space 300 is shown in a carrying configuration.

The storage space 300 is further formed with a carrying strap 306 adapted for carrying the IPK from one location to another. The storage space 300 is further formed with a securing mechanism 308 adapted to keep connected the first and fifth storage chambers 310 and 350 respectively, when in a carrying position.

With reference to FIG. 12, the storage chamber 310 is formed as an essentially hollow triangular prism with a top and bottom triangular surfaces 312 and 314 respectively, with sidewalls 316a, 316b and 316c extending therebetween. The top surface 312 is constituted by a cover 311, pivotally articulated to the sidewall 316b. The storage chamber 310 is further formed with a door like opening 313 in the sidewall 316a and a window like opening 315 in the sidewall 316c.

Reverting to FIG. 10, it would be appreciated that the sidewalls 316a and 316c of the storage chamber 310 are mated against the corresponding sidewalls of the two adjacent storage chambers 320 and 350, on each side thereof, and the sidewall 316b faces in outwardly. In other words, the edges 317a and 317b of the storage space 310, are co-aligned with the edges 327b and 357a of storage chambers 320 and 357 respectively.

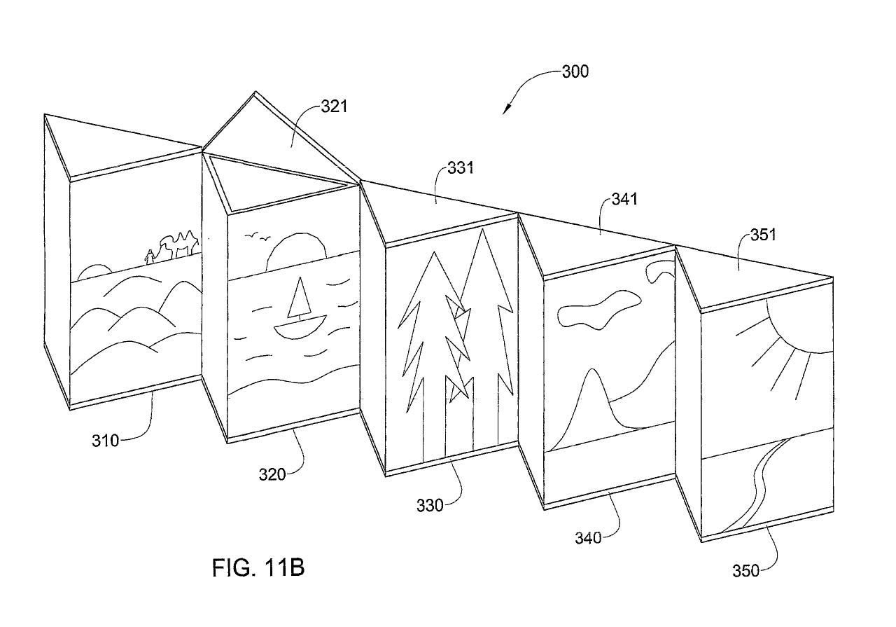

Turning to FIG. 11A, the storage space 300 is shown in a semi-deployed configuration. In this position, the securing mechanism 308 is unlatched, whereby the storage chambers 310-350 are free to pivotally displace about the connecting edges between two adjacent storage chambers to form a chamber chain. With further reference to FIG. 11B, the chamber chain may assume a variety of positions. Each of the storage chambers 310-350 may be painted and decorated to allow acting out various stories, whereby the storage space 300 also constitutes the changeable setting.

It would also be appreciated that in all the configurations, and previously described embodiments, a different IPK may be designed for a different theme. Thus, for example, an IPK may be sold having a ‘desert’ theme, ‘magic’ theme etc.

While this invention has been particularly shown and described with references to preferred embodiments thereof, it will be understood by those skilled in the art that various changes in form and details may be made therein without departing from the scope of the invention encompassed by the appended claims.

What is claimed is:

1. An interactive play kit comprising at least one changeable setting, at least one representative object, a primary cue-card containing a fixed outline of a story adapted for development of a primary story, and at least one secondary cue-card containing guidelines adapted for development of a secondary story being a variation of said primary story, wherein said at least one representative object is adapted to be movably placed and displaced within said at least one changeable setting so as to convey either said primary story or said secondary story.

2. The interactive play kit according to claim 1, said kit further comprising a storage space adapted to store at least one of the following:
said changeable setting;
said primary cue-card;
said secondary cue-card; and
said representative object.

3. The interactive play kit according to claim 2, wherein said storage space constitutes at least a part of said changeable setting.

4. The interactive play kit according to claim 3, wherein said storage is constituted by a plurality storage chambers.

5. The interactive play kit according to claim 4, wherein said storage chambers are pivotally interconnected to form a chamber chain.

6. The interactive play kit according to claim 5, wherein said storage chamber comprises five storage chambers, providing the storage chamber, and consequently the play kit a pentagonal configuration.

7. The interactive play kit according to claim 5, wherein said storage chamber further comprises a securing mechanism adapted for connecting the distal storage chambers of the chamber chain.

8. The interactive play kit according to claim 1, wherein said changeable setting forms a stage with decorations.

9. The interactive play kit according to claim 1, wherein said changeable setting is constituted by two or more interconnected panels.

10. The interactive play kit according to claim 9, wherein said panels are formed with anchor points corresponding to certain episodes and/or stages of either said primary or said secondary story to which said at least one representative object are adapted to be attached in a removable manner.

11. The interactive play kit according to claim 10, wherein said anchor points are constituted by a Velcro®, magnet or the like.

12. The interactive play kit according to claim 1, wherein said representative objects constitute characters, objects or ideas from either of said primary or said secondary story.

13. The interactive play kit according to claim 12, wherein said representative objects are modular, and have replaceable head/limbs/torso allowing a user to construct new representative figures adapted to fit various variations of either said primary or said secondary story.

14. The interactive play kit according to claim 1, wherein said kit comprises a leaflet containing both said primary cue-card and said secondary cue-card.

15. The interactive play kit according to claim 14, wherein said leaflet comprises a front side containing guidelines constituting said primary cue-card and a rear side containing guidelines constituting said secondary cue-card.

16. The interactive play kit according to claim 1, wherein said fixed outline of said primary cue-card is in one of the following forms:
an original text of the story;
a shortened pointer version summarizing the actions; and
positions of heroes, visual images version.

17. The interactive play kit according to claim 16, wherein said at least one secondary cue-card is adapted for personalization.

18. The interactive play kit according to claim 17, wherein said at least one secondary cue-card is divided into levels adapted to allow an individual to gradually develop said story.

19. The interactive kit according to claim 1, wherein both said primary cue-card and said at least one secondary cue-card, also contain a set of instructions adapted to aid an individual in playing out the story.

20. The interactive play kit according to claim 1, further comprising at least one data storage and/or display apparatus, e.g. audio/vide tape, CD etc. adapted to provide audio-visual input/output corresponding to said primary and/or said secondary story.

21. The interactive play kit according to claim 20, wherein said apparatus is adapted for import of music thereto.

22. A method for development of imagination, said method including:
a. Providing an interactive play kit comprising at least one changeable setting, at least one representative object, a primary cue-card containing a fixed outline of a story adapted for development of a primary story, and at least one secondary cue-card containing guidelines adapted for development of a secondary story being a variation of said primary story, wherein said at least one representative object is adapted to be movably placed and displaced within said at least one changeable setting so as to convey either said primary story or said secondary story;
b. Playing out said primary story according to the fixed outline of said primary cue-card by placing the appropriate representative objects within said at least one changeable setting as said story progresses; and
c. Playing out said secondary story, differing from said primary story, according to the guidelines of one of said at least one secondary cue-card by gradually placing the appropriate representative objects within said at least one changeable setting as said story variation progresses.
